(19) United States
(12) Patent Application Publication
(10) Pub. No.: US 2014/0034689 A1
(43) Pub. Date: Feb. 6, 2014

(54) HANGING SYSTEM

(71) Applicants: Debbie Moradzadeh, Santa Monica, CA (US); Sam Moradzadeh, Santa Monica, CA (US); Alexander Krayner, Los Angeles, CA (US)

(72) Inventors: Debbie Moradzadeh, Santa Monica, CA (US); Sam Moradzadeh, Santa Monica, CA (US); Alexander Krayner, Los Angeles, CA (US)

(21) Appl. No.: 13/567,709

(22) Filed: Aug. 6, 2012

(51) Int. Cl. A47G 25/28; F16M 13/02

(52) U.S. Cl. 223/85; 248/309.4

(57) ABSTRACT

A device is disclosed. The device contains a first magnet, and a material configured to magnetically couple with the first magnet with sufficient force to support the weight of a hanging garment.

### FIELD

The present invention relates to a system and a method of hanging garments, purses, ties, belts and/or any other clothing and/or accessories.

### BACKGROUND

As known in the art, clothing hangers 5 (shown in FIG. 1) are widely used throughout the world for temporary or long term storing of clothing items. Referring to FIG. 1, a hanger 5 configuration, as known in the art, typically includes wire, wood or plastic looped into a generally triangular shape 10, with the looped portion terminating in an upwardly projecting hook 15 configured to extend over a stationary hanging rod or rail within a closet or wardrobe cabinet.

To help people/users hang their garments on the hanger 5, some clothing manufacturers provide one or more hanging straps 20 attached to the inside of the garments 25 as shown in FIG. 1. Although hanging straps 20 provide a way to hang garments 25 on the hanger 5, when a person wears the garment 25, one or more hanging straps 20 tend to stick out from under the garment 25 and be visible to the public. To prevent this from happening, many people cut and remove the hanging straps 20 from the garments 25. Although removing the hanging straps 20 prevents them from sticking out when the garment 25 is being worn, it also prevents the garment 25 from being hanged properly on the hanger 5.

Contrary to the prior art, present invention provides exemplary systems that allow users to properly hang their garments on the hanger 5 without sticking out when the garment 25 is worn.

### SUMMARY

According to a first aspect of the present disclosure, a device is disclosed, the device comprising: a first magnet; and a material configured to magnetically couple with the first magnet with sufficient force to support at least a portion of the weight of a hanging garment.

According to a second aspect of the present disclosure, a method is disclosed, the method comprising: placing a portion of a garment between a first magnet and another material; and magnetically coupling the first magnet with the another material, wherein the portion of the garment is securely disposed between the first magnet and the another material.

According to a third aspect of the present disclosure, a clip for a garment hanger movable between an open position and a closed position is disclosed, the clip comprising: a first clip jaw comprising a first magnet, and a second clip jaw comprising material, wherein the second clip jaw is pivotally engaged with said first clip jaw such that the magnet and the material are magnetically coupled to each other when the clip is in a closed position.

### BRIEF DESCRIPTION OF THE FIGURES

FIG. 1 depicts a hanger and a garment as know in the prior art.

FIGS. 2a-b depict an exemplary hanging system according to the present disclosure.

FIGS. 2c-d depict the exemplary hanging system as shown in FIGS. 2a-b and another exemplary hanging system according to the present disclosure.

FIG. 3a depicts another exemplary hanging system according to the present disclosure.

FIG. 3b depicts another exemplary hanging system according to the present disclosure.

FIG. 4 depicts another exemplary hanging system according to the present disclosure.

FIGS. 5a-b depict another exemplary hanging system according to the present disclosure.

FIGS. 5c and 5e depict another exemplary hanging system according to the present disclosure.

FIG. 5d depicts another exemplary hanging system according to the present disclosure.

FIGS. 6a-e depict another exemplary hanging system according to the present disclosure.

FIGS. 7a-f depict another exemplary hanging system according to the present disclosure.

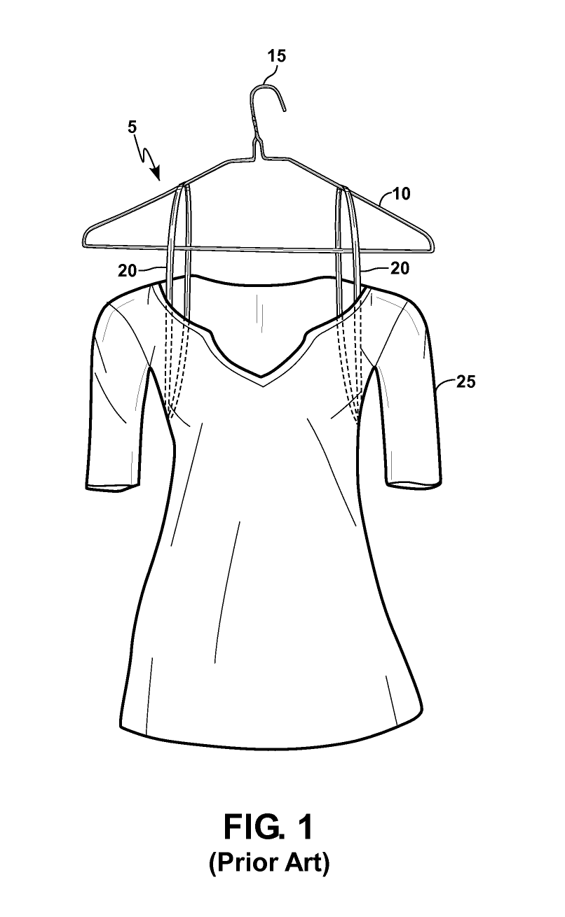

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements, and are not drawn to scale.

### DETAILED DESCRIPTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

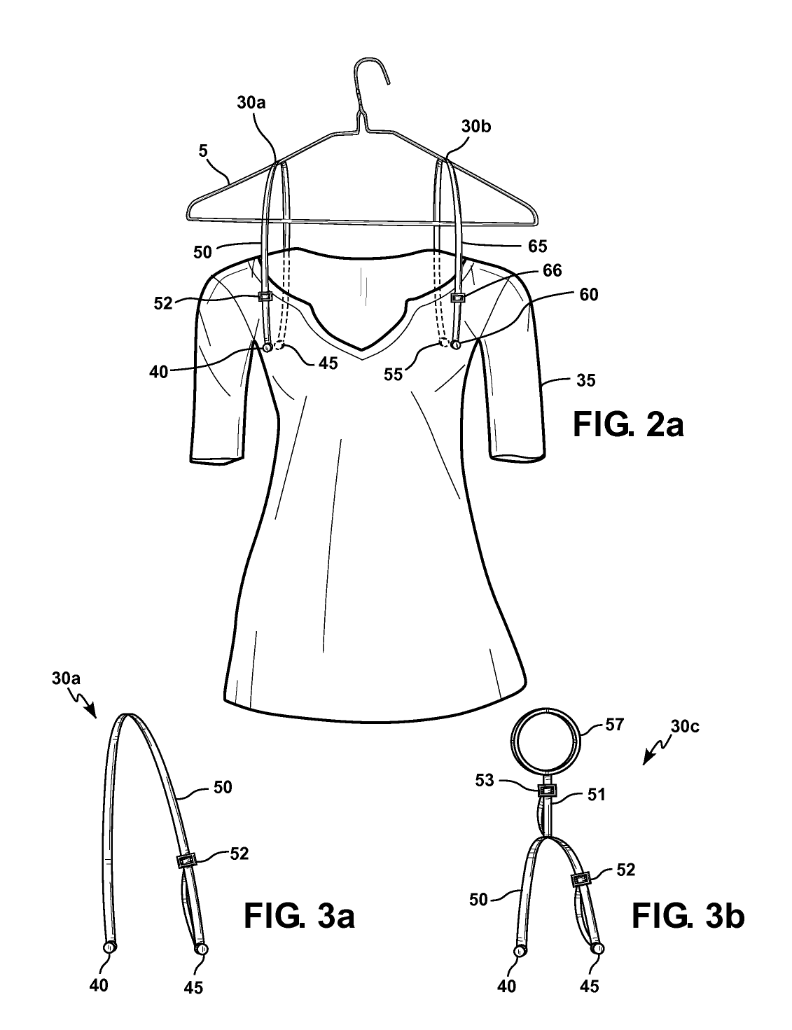

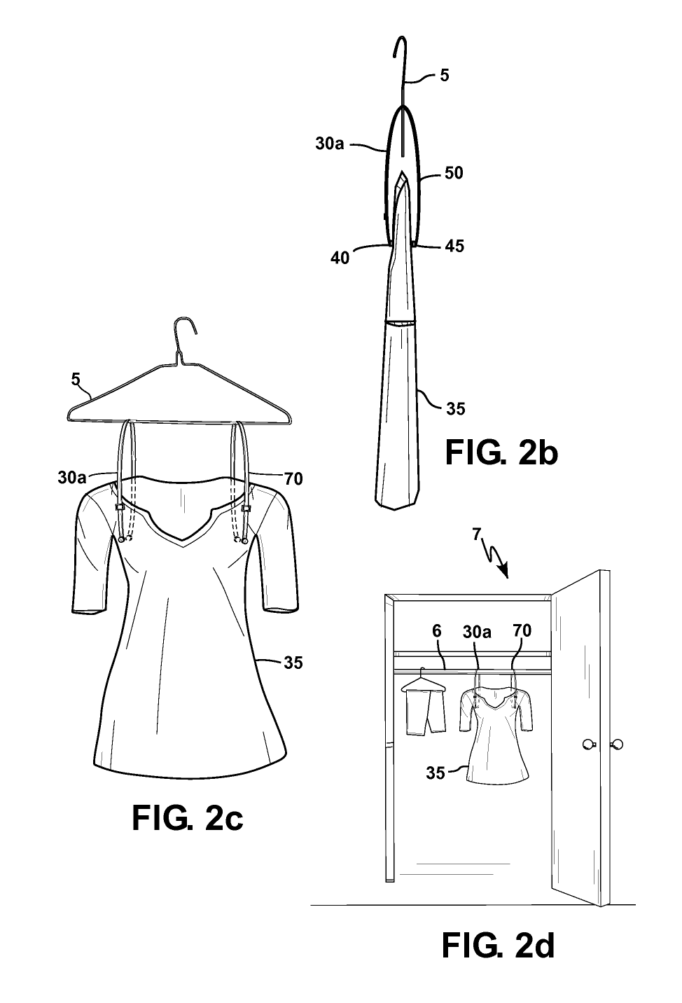

Referring to FIGS. 2a-b and 3a-b, in one exemplary embodiment according to the present disclosure, a hanging system 30a and/or 30b and/or 30c may be used to hang one or more garments 35 on the hanger 5. In one exemplary embodiment according to the present disclosure, the hanging system 30a and/or 30c may comprise a first magnetic end 40 and a second magnetic end 45 as shown in FIGS. 2a-b and 3a-b. The first magnetic end 40 may be coupled with the second magnetic end 45 using a strap 50 and/or 51 as shown in FIGS. 3a-b. The strap 51 may comprise a loop 57 configured to connect with a hanger (not shown) When a user wants to hang the garment 35, the user may place a portion of the garment 35 between the first magnetic end 40 and the second magnetic end 45 and allow both magnetic ends 40 and 45 to magnetically couple to each other through the portion of the garment 35 as shown, for example, in FIGS. 2a-b. The magnetic forces between the magnetic ends 40 and 45 of the hanging system 30a may be sufficient to hang the garment 35 on the hanger 5 without the garment 35 falling on to the floor. FIG. 2b depicts a side view of the garment 35 being retained by the hanging system 30a.

In one exemplary embodiment, the length of the strap 50 and/or the strap 51 may be adjusted using buckle 52 and/or 53 to allow the user to increase or decrease the length of the hanging system 30a and/or 30c. In an exemplary embodiment, the strap 50 and/or 51 may comprise rope or rope like material, metallic material, threads or yarn, plastic material, rubber material, wire, fabric material, leather material or any other material that may be used to support the weight of the garment 35 while it is being supported by the system 30a and/or 30c. In another exemplary embodiment, the strap 50 and or strap 51 may be coupled (not shown) with the hanger 5.

Although magnets 40 and 45 are depicted as being round, it is to be understood that they may be formed into other shapes. For example, magnet 40 and/or 45 may be rectangular or oval.

In another exemplary embodiment, another hanging system 30b may be used in conjunction with the handing system 30a to hang the garment 35 on the hanger 5 as shown in FIG. 2a. Similarly to hanging system, 30a, the hanging system 30b may comprise a first magnetic end 55 and a second magnetic end 60 as shown in FIGS. 2b. The first magnetic end 55 may be coupled with the second magnetic end 60 using a strap 65. In an exemplary embodiment, the length of the strap 65 may be adjusted using a buckle 66 shown in FIG. 2a. In an exemplary embodiment, the strap 65 may comprise rope or rope like material, metallic material, threads or yarn, plastic material, rubber material, wire, fabric material, leather material or any other material that may be used to support the weight of the garment 35 while it is being supported by the system 30b.

Although magnets 55 and 60 are depicted as being round, it is to be understood that they may be formed into other shapes. For example, magnet 55 and/or 60 may be rectangular or oval.

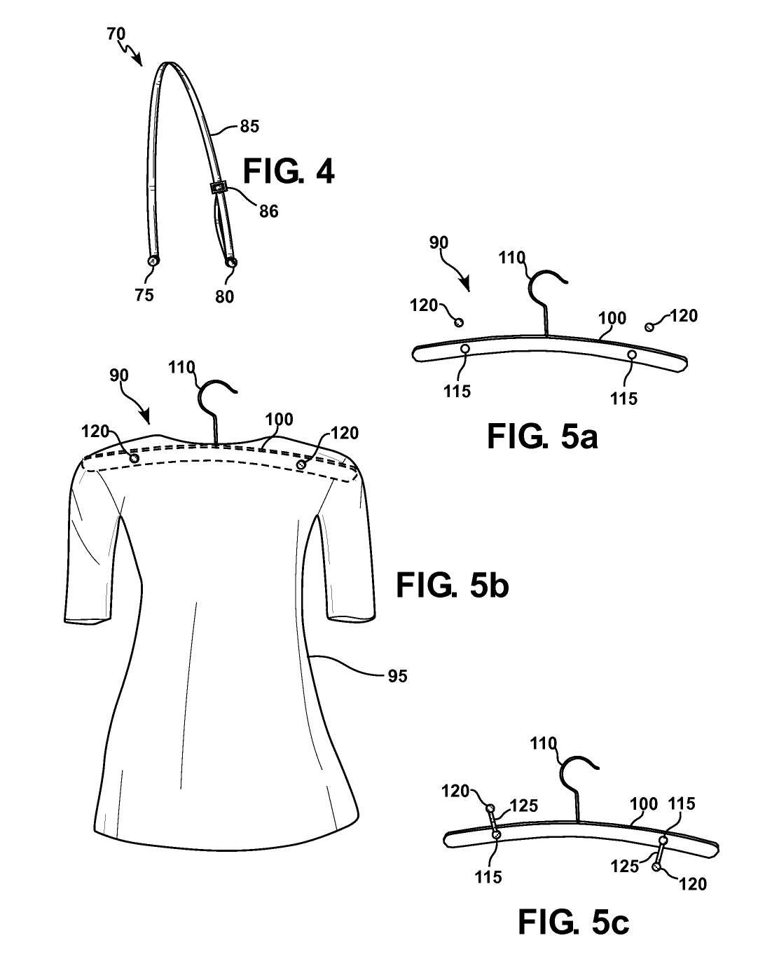

In another exemplary embodiment, a hanging system 70 (shown in FIGS. 2c and 4) may also be used to hang the garment 35 on the hanger 5. The hanging system 70 may comprise a first magnetic end 75 and a second end 80 as shown in FIG. 4. The first magnetic end 75 may be coupled with the second end 80 using a strap 85. The second end 80 may comprise metallic material or any other material that may be magnetically coupled with the first magnetic end 75. When a user wants to hang a garment, the user may place a portion of the garment between the first magnetic end 75 and the second end 80 and allow both ends 75 and 80 to magnetically couple with each other through the portion of the garment as shown in FIG. 2c. In an exemplary embodiment, the length of the strap 85 may be adjusted using a buckle 86 as shown in FIG. 4. In an exemplary embodiment, the strap 85 may comprise rope or rope like material, metallic material, threads or yarn, plastic material, rubber material, wire, fabric material, leather material or any other material that may be used to support the weight of the garment 35 while it is being supported by the system 70. In another exemplary embodiment, the strap 85 may be coupled (not shown) with the hanger 5.

Although magnet 75 and second end 80 are depicted as being round, it is to be understood that they may be formed into other shapes. For example, magnet 75 and/or second end 80 may be rectangular or oval.

Although FIGS. 2a-b depict the hanging system 30a and/or 30b as being applied over the top of the hanger 5. It is to be understood that the hanger system 30a and/or 30b and/or 70 may also be applied through the hanger 5 as shown in FIG. 2c. It is to be also understood that the hanger system 30a and/or 30b and/or 70 may be applied directly to the stationary hanging rod or rail 6 within a closet or wardrobe cabinet 7 as shown in FIG. 2d.

Although systems 30a-c and 70 are depicted as supporting garment 35, it is to be understood that systems 30a-c and 70 may also be used to hang, for example, shirts, pants, purses, ties, belts or any other clothing and/or accessories.

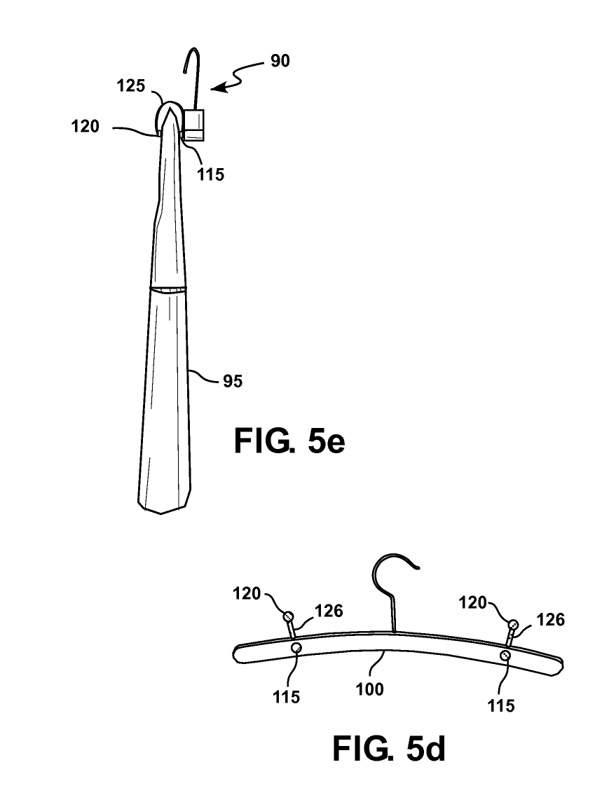

In another exemplary embodiment, a hanging system 90 (shown in FIGS. 5a-e) may also be used to hang a garment 95. The hanging system 90 may comprise a frame 100 and a hook 110 projecting from the frame 100. The hanging system 90 may further comprise one or more magnets 115 coupled with the frame 100. The hanging system 90 may also comprise one or more elements 120. In an exemplary embodiment, a user may place a portion of a garment 95 adjacent the magnets 115 and magnetically couple magnets 115 with elements 120 through the portion of the garment 95 as shown in FIG. 5b.

In an exemplary embodiment, elements 120 may comprise metallic material or any other material that may be magnetically coupled with the magnet 115. In another exemplary embodiment, element 120 may comprise another magnet. Although magnet 115 and element 120 are depicted as being round, it is to be understood that they may be formed into other shapes. For example, magnet 115 and/or element 120 may be rectangular or oval.

In an exemplary embodiment, each magnet 115 may be coupled with each element 120 using material 125 as shown in FIGS. 5c and 5e. FIG. 5e depicts a side view of the garment 95 being retained by the hanging system 90. In another exemplary embodiment, the frame 100 may be coupled with each element 120 using material 126 as shown in FIG. 5d. Material 125 and/or material 126 may be any flexible material that would allow magnet 115 to magnetically couple with element 120. Material 125 and/or material 126 may be plastic, rubber, and/or metal. It should be understood that placement of magnet 115 and element 120 may be switched. For example, the element(s) 120 may be coupled to the frame 100 (not shown) instead of the magnet(s) 115.

Although the system 90 is depicted as supporting garment 95, it is to be understood that the system 90 may also be used to hang, for example, shirts, pants, purses, ties, belts or any other clothing and/or accessories.

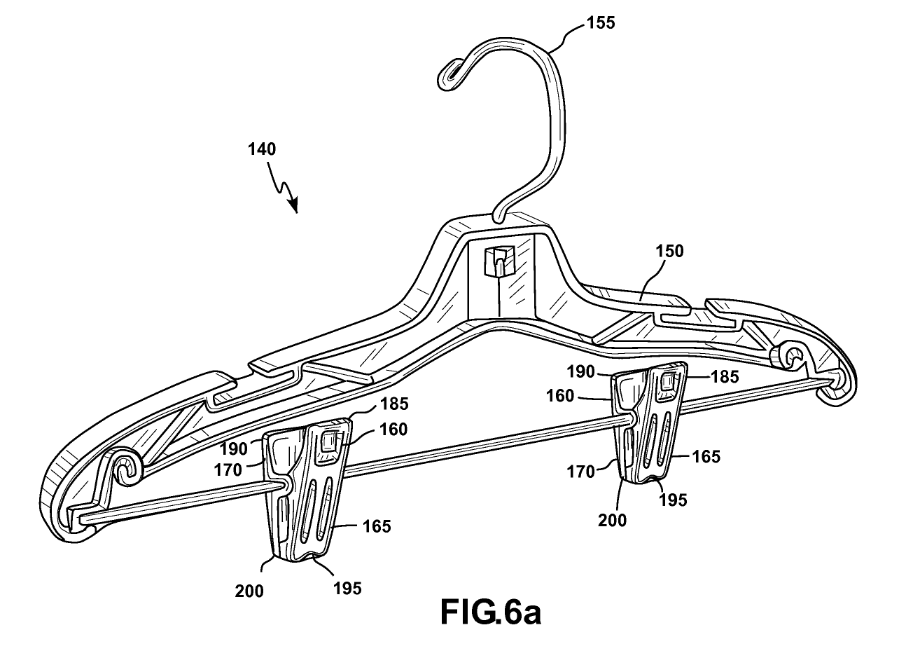

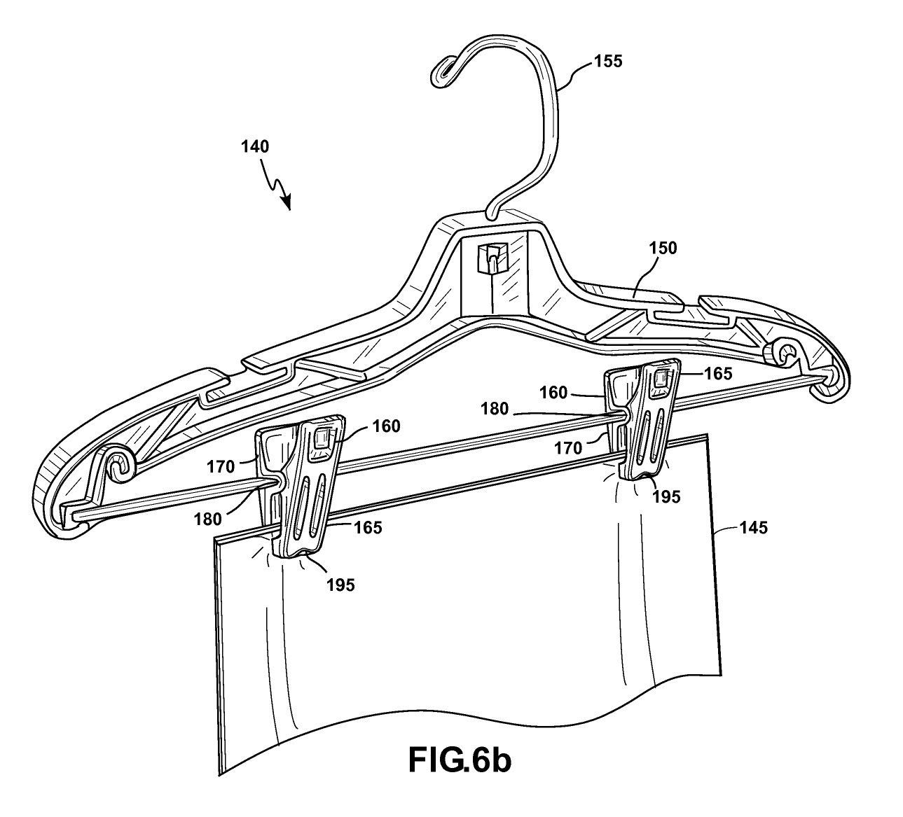

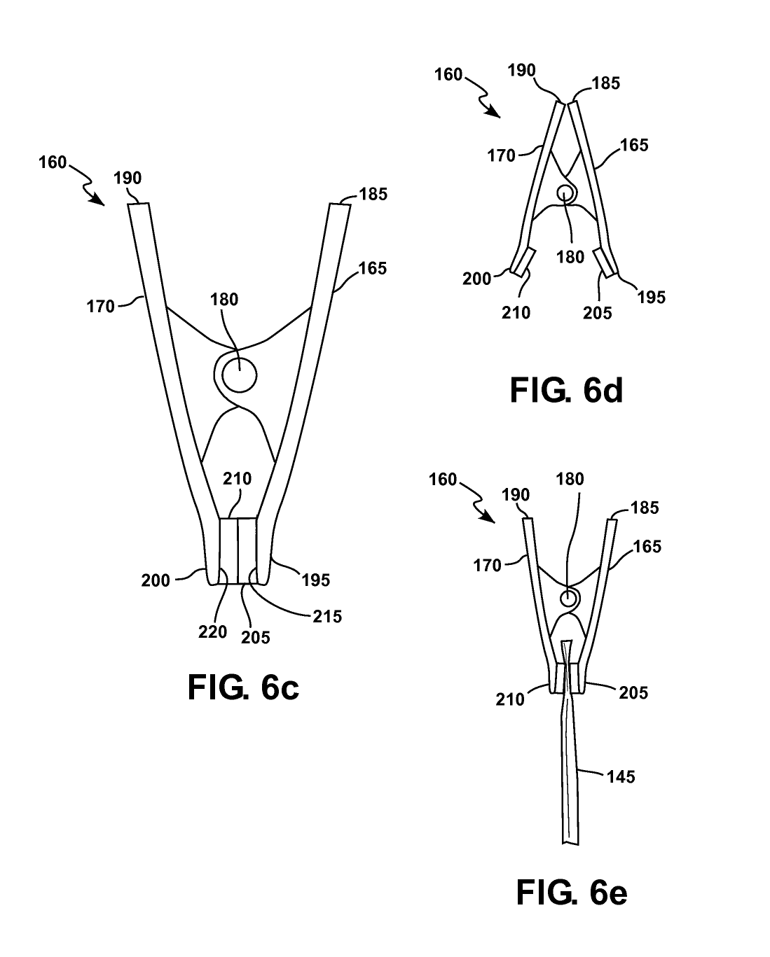

In another exemplary embodiment, a hanging system 140 (shown in FIGS. 6a-e) may also be used to hang a garment 145. The hanging system 140 may comprise a frame 150 and a hook 155 projecting from the frame 150. The hanging system 140 may further comprise one or more clips 160 coupled with the frame 150. FIG. 6c depicts a side view of one of the clips 160 in a closed position, while FIG. 6d depicts a side view of one of the clips 160 in an open position. The clip 160 may be formed from clip jaws 165 and 170 engaged along a pivotal location 180, with each clip jaw comprising an engagement end 185, 190 for compressive engagement by a user's hand and a clamping end 195, 200 for clamping around the garment 145. FIG. 6e depicts the garment 145 being retained by one of the clips 160. In one exemplary embodiment, the clamping end 195 may comprise a magnet 205 and the clamping end 200 may comprise material 210. In one exemplary embodiment, the material 210 may comprise another magnet. In another exemplary embodiment, the material 210 may comprise metallic material or any other material that may be magnetically coupled with the magnet 205.

In one exemplary embodiment, the magnet 205 may be coupled to the inner surface 215 of the clamping end 195. The magnet 205 may be adhered to the inner surface 215 with an adhesive or the like. Other methods of attaching the magnet 205 to the clip jaw 165, such as, for example, by purely mechanical means that avoid the need for adhesives or the like, may be also be used.

In another exemplary embodiment, the material 210 may be coupled to the inner surface 220 of the clamping end 200. The material 210 may be adhered to the inner surface 220 with an adhesive or the like. Other methods of attaching the material 210 to the clip jaw 170, such as, for example, by purely mechanical means that avoid the need for adhesives or the like, may be also be used.

Although the system 140 is depicted as supporting garment 145, it is to be understood that the system 140 may also be used to hang, for example, shirts, pants, purses, ties, belts or any other clothing and/or accessories.

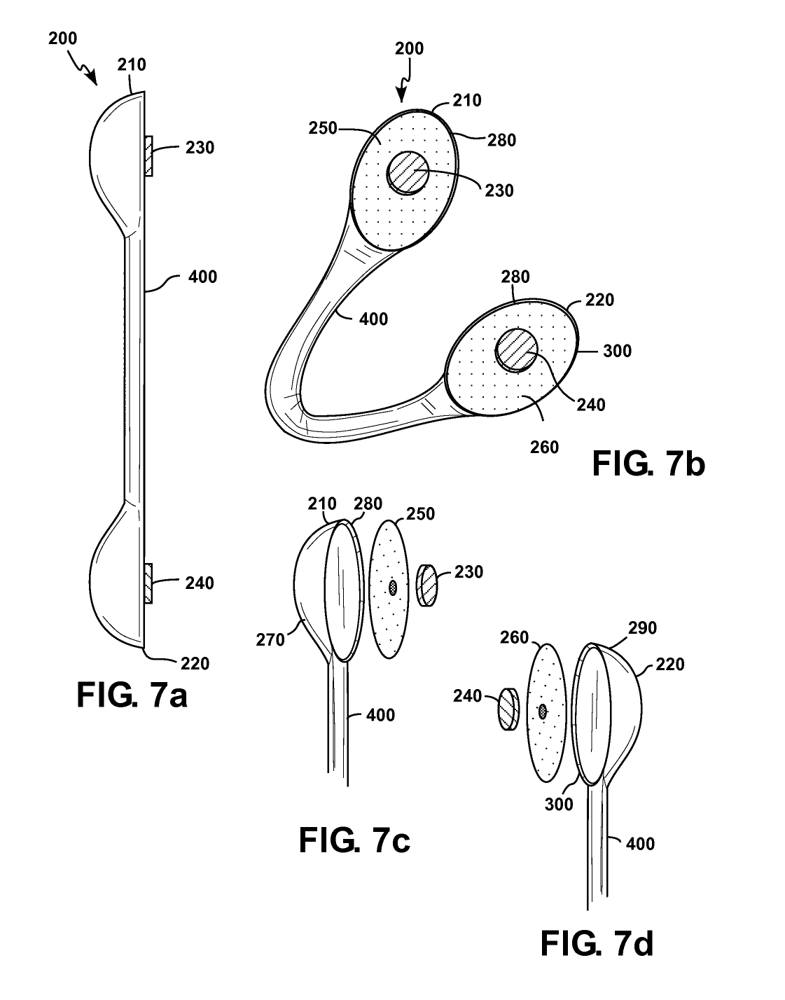

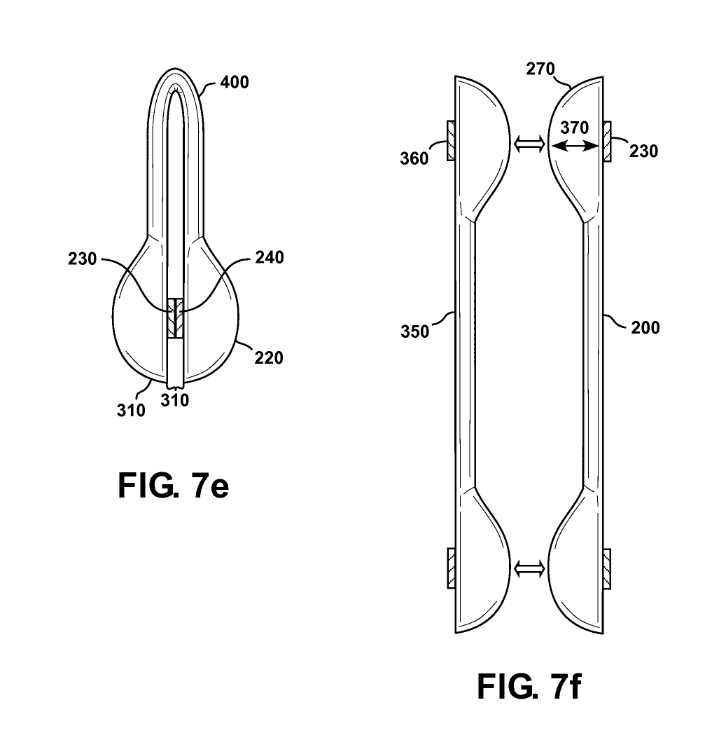

In another exemplary embodiment, a hanging system 200 (shown in FIGS. 7a-e) may also be used to hang a garment (not shown) on a hanger (not shown). The hanging system 200 may comprise a first magnetic end 210 and a second end 220 as shown in FIGS. 7a-b. Referring to FIGS. 7a-c, the first magnetic end 210 may comprise a magnet 230. Referring to FIGS. 7a-b and 7d, the second end 220 may comprise material/element 240. The material 240 may comprise another magnet, metallic material or any other material that may be magnetically coupled with the magnet 230. Although magnet 230 and material 240 are depicted as being flat and round, it is to be understood that they may be formed into other shapes. For example, magnet 230 and/or material 240 may be rectangularly shaped, sphericaly shaped, pyramidal shaped and/or ovaly shaped. In an exemplary embodiment, the magnet 230 and/or element 240 may be covered by a material comprising rubber, plastic or any other material that may prevent the garment from slipping from the hanging system 200.

The first magnetic end 210 may be coupled with the second end 220 using a strap 400. When a user wants to hang a garment, the user may place a portion of the garment between the first magnetic end 210 and the second end 220 and allow both ends 210 and 220 to magnetically couple with each other through the portion of the garment (not shown). In an exemplary embodiment, the length of the strap 400 may be adjusted using a buckle (not shown). In an exemplary embodiment, the strap 400 may comprise rope or rope like material, metallic material, threads or yarn, plastic material, rubber material, wire, fabric material, leather material or any other material that may be used to support the weight of the garment while it is being supported by the system 200.

The system 200 may be used to hang, for example, shirts, pants, purses, ties, belts or any other clothing and/or accessories.

In an exemplary embodiment, the first magnetic end 210 may further comprise material 250 configured to support the magnet 230. The magnet 230 may be adhered to the material 250. The material 250 may comprise plastic material, non-metallic material, rubber material or any other comparable material configured to support the magnet 230.

In an exemplary embodiment, the second end 220 may further comprise material 260 configured to support the element 240. The element 240 may be adhered to the material 260. The material 260 may comprise plastic material, non-metallic material, rubber material or any other comparable material configured to support the element 240.

In an exemplary embodiment, the first magnetic end 210 may further comprise a housing 270 configured to accommodate the material 250. The material 250 may be coupled with the housing 270 using, for example, adhesive. The housing 270 may be configured to provide an outer edge 280.

In an exemplary embodiment, the second end 220 may further comprise a housing 290 configured to accommodate the material 260. The material 260 may be coupled with the housing 290 using, for example, adhesive. The housing 290 may be configured to provide an outer edge 300.

Referring to FIGS. 7a-e, in an exemplary embodiment, the edges 280 and 300 may be separated from each other at a predetermined distance 310 when the magnetic end 210 is magnetically coupled to the second end 220. In an exemplary embodiment, the distance 310 may be sufficient to allow a user to separate the magnetic end 210 and the second end 220 using their finger(s) and/or nail(s).

FIG. 7f depicts a hanging system 200 and 350. The hanging system 350 may be similar to the hanging system 200 described above. In an exemplary embodiment, the housing 270 may be configured to minimize the magnetic force between the magnet 230 and the magnet 360. In an exemplary embodiment, the housing 270 may, for example, comprise non-metallic material, rubber material, fabric or any other material that may minimize the magnetic force between the magnets 230 and 360. In another exemplary embodiment, the hosing 270 may be shaped so as to minimize the magnetic attraction between the magnets 230 and 360. For example, the housing 270 may comprise a semispherical shape to provide separation distance 370. The separation distance 370 separates the magnets 230 and 360 thereby minimizing the magnetic attraction between these magnets. It is to be understood that the housing 270 may comprise other shapes that provide the separation distance 370.

While several illustrative embodiments of the invention have been shown and described, numerous variations and alternative embodiments will occur to those skilled in the art. Such variations and alternative embodiments are contemplated, and can be made without departing from the scope of the invention as defined in the appended claims.

As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “step(s) for . . . ”

What is claimed is:

1. A device comprising:
a first magnet; and
a material configured to magnetically couple with the first magnet with sufficient force to support at least a portion of the weight of a hanging garment.

2. The device of claim 1, further comprising a strap coupling the first magnet and the material.

3. The device of claim 1, wherein the material comprises a second magnet.

4. The device of claim 1, wherein the material comprises metal.

5. A method comprising:
placing a portion of a garment between a first magnet and another material; and
magnetically coupling the first magnet with the another material, wherein the portion of the garment is securely disposed between the first magnet and the another material.

6. The method of claim 5, wherein the first magnet and the another material are coupled together with a strap.

7. The method of claim 6, further comprising hanging the strap on a hanger.

8. The method of claim 5, wherein the another material comprises a second magnet.

9. The method of claim 5, wherein the another material comprises metal.

10. A clip for a garment hanger movable between an open position and a closed position, the clip comprising:
a first clip jaw comprising a first magnet, and
a second clip jaw comprising material, wherein the second clip jaw is pivotally engaged with said first clip jaw such that the magnet and the material are magnetically coupled to each other when the clip is in a closed position.

11. The clip of claim 10, wherein the material comprises a second magnet.

12. The device of claim 10, wherein the material comprises metal.
